(19) United States
(12) Patent Application Publication
(10) Pub. No.: US 2016/0046489 A1
(43) Pub. Date: Feb. 18, 2016

(54) OZONE GENERATOR

(71) Applicant: NGK INSULATORS, LTD., Nagoya-City (JP)

(72) Inventors: Tatsuya TERAZAWA, Kasugai-City (JP); Shoji YOKOI, Nagoya-City (JP); Naoya TAKASE, Konan-City (JP)

(21) Appl. No.: 14/823,191

(22) Filed: Aug. 11, 2015

(30) Foreign Application Priority Data
Aug. 15, 2014 (JP) 2014-165349

(51) Int. Cl. C01B 13/11

(52) U.S. Cl. CPC C01B 13/11; C01B 2201/90

(57) ABSTRACT

An ozone generator includes a transformer, a direct current power supply unit connected to a primary side of the transformer, a reactor connected to a secondary side of the transformer, a semiconductor switch connected between one end of a primary winding of the transformer and the direct current power supply unit, and a control circuit for implementing ON-OFF control of the semiconductor switch at a set switching frequency to thereby apply a voltage to the reactor. The interior of the reactor is set to conditions for making it easy to generate an electric discharge therein.

### CROSS-REFERENCE TO RELATED APPLICATION

This application is based upon and claims the benefit of priority from Japanese Patent Application No. 2014-165349 filed on Aug. 15, 2014, the contents of which are incorporated herein by reference.

### BACKGROUND OF THE INVENTION

1. Field of the Invention

The present invention relates to an ozone generator, and more particularly to an ozone generator which is suitable for in-vehicle applications, for example.

2. Description of the Related Art

Generally, the discharging circuits for ozone generators include, for example, a high-frequency power supply (RF power supply) disclosed in Japanese Laid-Open Patent Publication No. 11-233294, and discharging circuits disclosed in Japanese Patent No. 3811681, Japanese Patent No. 4418212, and Japanese Laid-Open Patent Publication No. 2014-036502.

The high-frequency power supply disclosed in Japanese Laid-Open Patent Publication No 11-233294 has an oscillating circuit, a power amplifier for amplifying a high-frequency signal output from the oscillating circuit, and a matching box for matching the impedance of the high-frequency power supply and the impedance of a load. Electric power output from the power amplifier is supplied through the matching box to the load.

Japanese Patent No 3811681 and Japanese Patent No. 4418212 disclose pulse generating circuits of the opening switch type, which are of a highly simple circuit configuration including a transformer, a first semiconductor switch, and a second semiconductor switch, which are connected in series across a DC power supply. The transformer has a primary winding having one end connected to the anode terminal of the first semiconductor switch, and a diode is connected such that its cathode is connected to the other end of the primary winding and its anode is connected to the gate terminal of the first semiconductor switch.

When the second semiconductor switch is switched on, the first semiconductor switch is also rendered conductive, whereby the voltage of the DC power supply is applied to the primary winding of the transformer to thereby store induction energy in the transformer. Thereafter, when the second semiconductor switch is switched off, the first semiconductor switch is also quickly turned-off, whereby a sharply rising high-voltage pulse having an extremely small width is generated across the secondary winding of the transformer. The high-voltage pulse can be output from the pulse generating circuit through its output terminals.

Japanese Laid-Open Patent Publication No 2014-036502 discloses a pulse generating circuit in which an oscillating current is passed through the primary side of a transformer during an ON period of a semiconductor switch to thereby output a pulse voltage from the output terminal of the secondary side of the transformer during the ON period thereof.

### SUMMARY OF THE INVENTION

The ozone generator is, e.g., mounted in a vehicle. In the ozone generator for use of in-vehicle applications, for example, ozone generated by the ozone generator is mixed into injected fuel in synchronization with the injection of fuel into a combustion chamber, to thereby facilitate ignition of the fuel.

In the pulse generating circuits disclosed in Japanese Patent No. 3811681 and Japanese Patent No. 4418212, a turn-on operation on the semiconductor switch is carried out at the time the current in the primary side of the transformer is zero (ZCS: Zero Current Switching), and a turn-off operation on the semiconductor switch is carried out at the time the current in the primary side takes a predetermined peak value (hard switching). Therefore, there is a limitation in reducing a switching loss and noise.

The pulse generating circuit disclosed in Japanese Laid-Open Patent Publication No 2014-036502 may possibly be unable to supply a sufficient amount of energy for producing electric discharges because a pulse voltage is generated only during the ON period of the semiconductor switch.

The present invention has been made in view of the above problems. It is an object of the present invention to provide an ozone generator which is capable of further reducing a switching loss and noise and increasing switching efficiency and the efficiency with which to generate ozone.

[1] An ozone generator according to a first aspect of the present invention includes a transformer, a direct current power supply unit connected to a primary side of the transformer, a reactor connected to a secondary side of the transformer, a semiconductor switch connected between one end of a primary winding of the transformer and the direct current power supply unit, and a control circuit configured to implement ON-OFF control of the semiconductor switch using a set switching frequency to thereby apply a voltage to the reactor, wherein an interior of the reactor is set to conditions for making it easy to generate an electric discharge in the reactor.

The conditions for making it easy to cause an electric discharge in the reactor include a negative pressure established in the reactor, or a small discharge gap between the discharge electrodes disposed in the reactor, or both of them.

Since the negative pressure is established in the reactor or the discharge gap is reduced, an electric discharge is made easy to generate in the reactor. The primary current of the transformer is an oscillating current based on the resonance of an LC circuit including at least the leakage inductance of the transformer, the winding capacitance of the transformer, and the electrode capacitance between the discharge electrodes of the reactor. Consequently, it is not necessary to carry out a turn-off operation on the semiconductor switch at the peak value of the primary current as is the case with the related art. Specifically, it is possible to carry out a turn-off operation on the semiconductor switch at the time the primary current flows in a negative direction.

Therefore, it is possible to switch ON and OFF the semiconductor switch according to ZCS for thereby reducing a switching loss and noise and increasing the switching efficiency and the efficiency with which ozone is generated.

[2] In the first aspect of the present invention, the control circuit should preferably carry out a turn-on operation on the semiconductor switch at the time a primary current of the transformer is zero, and carry out a turn-off operation on the semiconductor switch at the time the primary current flows in a negative direction.

[3] In the first aspect of the present invention, the primary current that flows during an ON period of the semiconductor switch may be an oscillating current based on the resonance of an LC circuit including at least a leakage inductance of the transformer, a winding capacitance of the transformer, and a capacitance between discharge electrodes of the reactor, and the leakage inductance may be established such that a turn-off operation on the semiconductor switch is carried out during a period in which the primary current is flowing in the negative direction.

The primary current of the transformer is zero at the start point (turn-on time) of the ON period of the semiconductor switch. As a turn-off operation on the semiconductor switch is carried out during the period in which the primary current flows in the negative direction, the semiconductor switch can be switched OFF at the time the primary current becomes zero. Therefore, it is possible to switch ON and OFF the semiconductor switch according to ZCS.

[4] In the first aspect of the present invention, the primary current that flows during the ON period of the semiconductor switch may be an oscillating current based on the resonance of an LC circuit including at least the leakage inductance of the transformer, the winding capacitance of the transformer, and the capacitance between discharge electrodes of the reactor. The ON period of the semiconductor switch may be set to a value which may be longer than a ½ period of the primary current, and equal to or shorter than one period of the primary current. Since a turn-off operation on the semiconductor switch can be carried out during the period in which the primary current flows in the negative direction, it is possible to switch ON and OFF the semiconductor switch according to ZCS.

[5] In the first aspect of the present invention, an alternating current voltage may be applied to the reactor during an OFF period of the semiconductor switch.

During the OFF period after the ON period of the semiconductor switch, an alternating current voltage, i.e., a negative voltage and a positive voltage, is successively applied to the reactor. The supply of energy into the reactor is thus increased unlike the case where a pulse voltage is generated only during the ON period of the semiconductor switch. The ozone generator is thus capable of generating ozone more efficiently due to a synergetic effect of an electric discharge that is made easy to cause by the negative pressure in the reactor or the small discharge gap or both of them and the increased supply of energy into the reactor.

[6] In the first aspect of the present invention, the reactor may include one or more electrode pairs each including two discharge electrodes spaced from each other by a predetermined gap length, and the reactor may generate ozone by allowing a source gas to pass through a space between at least the two discharge electrodes of the electrode pair and then producing electric discharge between the two discharge electrodes by the voltage applied between the two discharge electrodes.

[7] In the first aspect of the present invention, the conditions for making it easy to generate an electric discharge in the reactor may include a negative pressure established in the reactor. The negative pressure may fall within a range from −0.01 to −0.10 MPa, for example.

[8] In the first aspect of the present invention, the conditions for making it easy to generate an electric discharge in the reactor may include a small discharge gap between the discharge electrodes disposed in the reactor. The discharge gap should preferably be 10 mm or less, more preferably 1 mm or less, or much more preferably 0.5 mm or less.

[9] In the first aspect of the present invention, the conditions for making it easy to generate an electric discharge in the reactor may include a negative pressure established in the reactor, and a small discharge gap between the discharge electrodes disposed in the reactor.

[10] An ozone generator according to a second aspect of the present invention includes a transformer, a direct current power supply unit connected to a primary side of the transformer, a reactor connected to a secondary side of the transformer, a semiconductor switch connected between one end of a primary winding of the transformer and the direct current power supply unit, and a control circuit configured to implement ON-OFF control of the semiconductor switch using a set switching frequency to thereby apply a voltage to the reactor, wherein a pressure in the reactor is set to a negative pressure.

[11] An ozone generator according to a third aspect of the present invention includes a transformer, a direct current power supply unit connected to a primary side of the transformer, a reactor connected to a secondary side of the transformer, a semiconductor switch connected between one end of a primary winding of the transformer and the direct current power supply unit, and a control circuit configured to implement ON-OFF control of the semiconductor switch using a set switching frequency to thereby apply a voltage to the reactor, wherein a discharge gap between discharge electrodes disposed in the reactor is small.

[12] An ozone generator according to a fourth aspect of the present invention includes a transformer, a direct current power supply unit connected to a primary side of the transformer, a reactor connected to a secondary side of the transformer, a semiconductor switch connected between one end of a primary winding of the transformer and the direct current power supply unit, and a control circuit configured to implement ON-OFF control of the semiconductor switch using a set switching frequency to thereby apply a voltage to the reactor, wherein a pressure in the reactor is set to a negative pressure and a discharge gap between discharge electrodes disposed in the reactor is small.

The ozone generator according to the present invention is capable of reducing a switching loss and noise and increasing the switching efficiency and the ozone generation efficiency.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a circuit diagram of an ozone generator according to an embodiment of the present invention;

FIG. 2 is a vertical cross-sectional view enlargedly showing main components of a reactor of the ozone generator;

FIG. 3 is a cross-sectional view taken alone line III-III of FIG. 2;

FIG. 4 is a timing chart showing a processing sequence of operation of an ozone generator according to a reference example; and

FIG. 5 is a timing chart showing a processing sequence of operation of the ozone generator according to the embodiment of the present invention.

### DESCRIPTION OF THE PREFERRED EMBODIMENTS

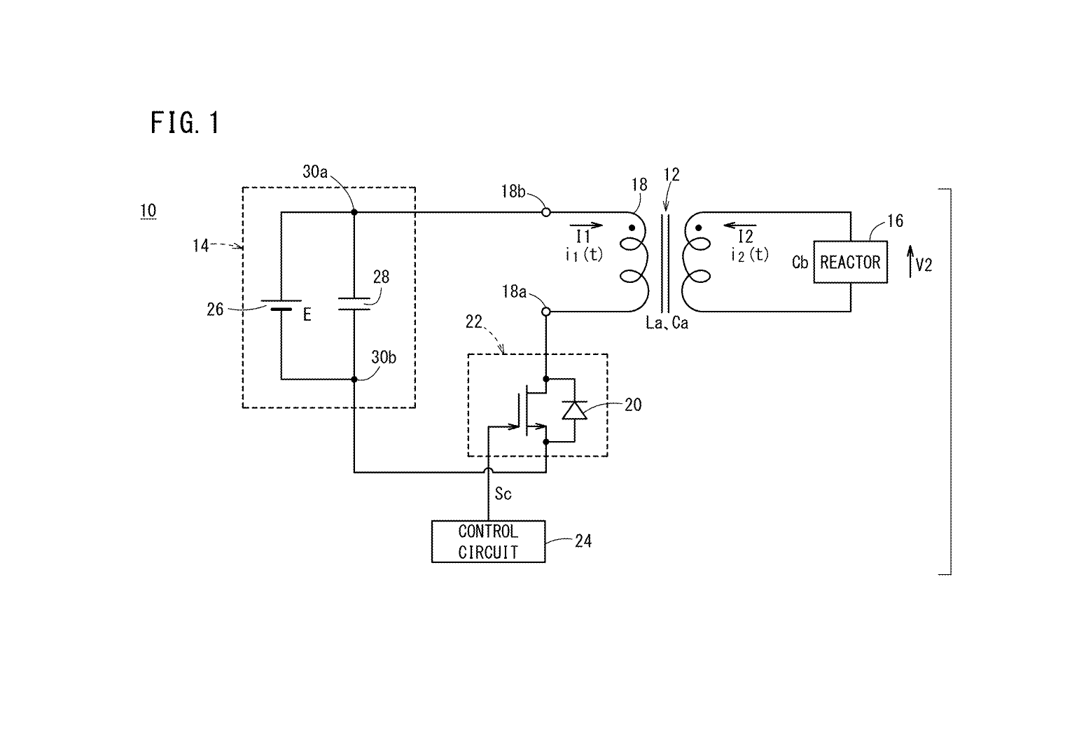

An ozone generator according to an embodiment of the present invention will be described below with reference to FIGS. 1 through 5.

As shown in FIG. 1, an ozone generator 10 according to an embodiment of the present invention includes a transformer 12, a direct current (DC) power supply unit 14 connected to the primary side of the transformer 12, a reactor 16 connected to the secondary side of the transformer 12, a semiconductor switch (switching unit) 22 connected between one end 18a of a primary winding 18 of the transformer 12 and the direct current power supply unit 14, and having a diode 20 connected in reverse-parallel, and a control circuit 24 for applying voltage to the reactor 16 by implementing ON-OFF control of the semiconductor switch 22.

The direct current power supply unit 14 is formed by connecting a direct current power supply 26 and a capacitor 28 in parallel. Therefore, a positive electrode terminal 30a of the direct current power supply unit 14 (node between a positive (+) terminal of the direct current power supply 26 and one electrode of the capacitor 28) and the other end 18b of the primary winding 18 are connected, and the semiconductor switch 22 is connected between a negative electrode terminal 30b of the direct current power supply unit 14 (node between a negative (−) terminal of the direct current power supply 26 and the other electrode of the capacitor 28) and the one end 18a of the primary winding 18. In the example of FIG. 1, the semiconductor switch 22 is provided on the part of the negative electrode terminal 30b of the direct current power supply unit 14. However, it is a matter of course that the same advantages can be obtained also in the case where the semiconductor switch 22 is provided on the part of the positive electrode terminal 30a.

As the semiconductor switch 22, a self-extinguishing device or a commutation extinguishing device may be used. In this embodiment, the semiconductor switch 22 uses a field effect transistor, e.g., a metal oxide semiconductor field effect transistor (MOSFET) having an internal diode 20 connected in reverse-parallel. The MOSFET may be a SiC-MOSFET using SIC (Silicon Carbide).

The control circuit 24 generates a switching control signal Sc for implementing ON-OFF control of the semiconductor switch 22. The switching control signal Sc from the control circuit 24 is applied to the gate of the semiconductor switch 22. By the control circuit 24, ON-OFF control of the semiconductor switch 22 is implemented.

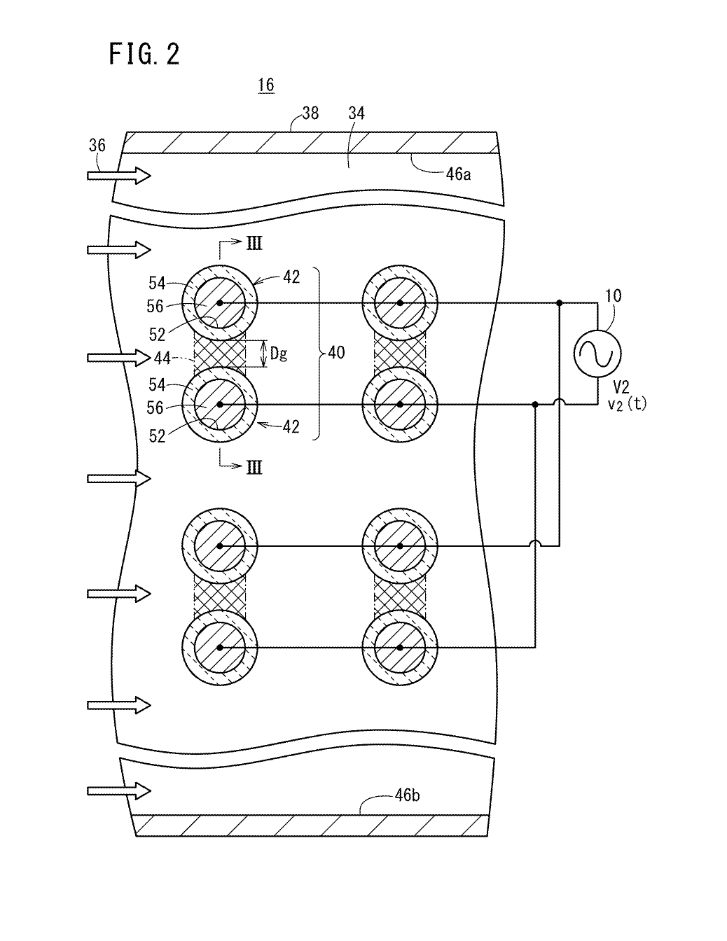

As shown in FIG. 2, the reactor 16 includes a casing 38 having a hollow portion 34 and at least one electrode pair 40 placed in the hollow portion 34 of the casing 38. A source gas 36 is supplied to the hollow portion 34. The electrode pair 40 comprises two discharge electrodes 42 spaced from each other by a predetermined gap length Dg.

The reactor 16 generates ozone by allowing the source gas 36 to pass through a space between at least two discharge electrodes 42 of the electrode pair 40 to thereby cause electric discharge between the two discharge electrodes 42. The space between two discharge electrodes 42 is a space where electric discharge occurs, and thus the space is defined as a discharge space 44.

In particular, in the embodiment of the present invention, a plurality of electrode pairs 40 are arranged in series or in parallel, or arranged in series and in parallel, between inner walls (one inner wall 46a and the other inner wall 46b) of the casing 38 that face each other. In the example of FIG. 2, the electrode pairs are arranged in series and in parallel.

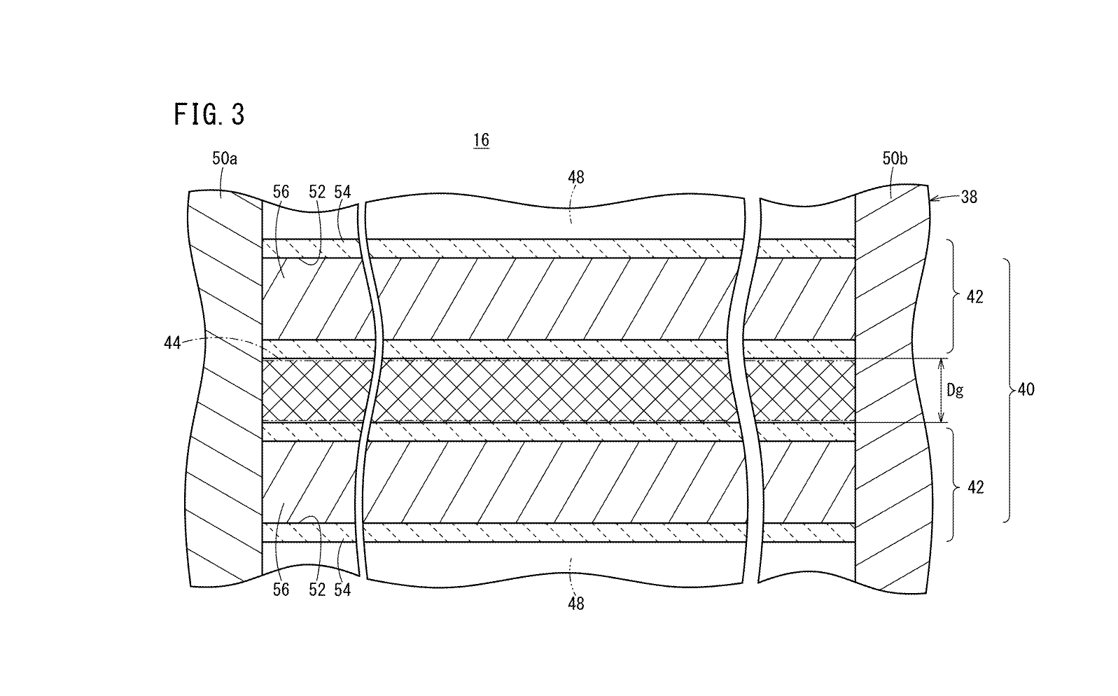

As shown in FIG. 3, each of the discharge electrodes 42 has a rod shape, and extends along a source gas passing surface 48 having the normal direction in the main flow direction of the source gas 36. Each of the discharge electrodes 42 extends between one side wall 50a and the other side wall 50b of the casing 38. That is, the discharge electrodes 42 extend across the hollow portion 34 of the casing 38 along the source gas passing surface 48, and are fixed to the one side wall 50a and the other side wall 50b of the casing 38. The main flow direction of the source gas 36 herein means a flow direction of the source gas 36 flowing at the central portion with directivity. This is intended to exclude directions of flow components without directivity in the marginal portions of the source gas 36.

Each of the discharge electrodes 42 includes a tubular dielectric body 54 having a hollow portion 52 and a conductor 56 positioned inside the hollow portion 52 of the dielectric body 54. In the example of FIGS. 2 and 3, the dielectric body 54 has a cylindrical shape, and the hollow portion 52 has a circular shape in transverse cross section. The conductor 56 has a circular shape in transverse cross section. It is a matter of course that the shapes of the dielectric body 54 and the conductor 56 are not limited to these shapes. The dielectric body 54 may have a polygonal cylindrical shape such as a triangle, quadrangle, pentagonal, hexagonal, or octagonal shape in transverse cross section. Correspondingly, the conductor 56 may have a polygonal columnar shape such as a triangle, quadrangle, pentagonal, hexagonal, or octagonal shape in transverse cross section.

The present embodiment is aimed at generation of ozone. Therefore, the source gas 36 may be a gas containing oxygen, for example.

Preferably, the conductor 56 is made of a material selected from a group consisting of molybdenum, tungsten, stainless steel, silver, copper, nickel, and alloy at least including one of these materials. As the alloy, for example, invar, kovar, Inconel (registered trademark), or Incoloy (registered trademark) may be used.

Further, preferably, the dielectric body 54 may be made of a ceramics material which can be fired at a temperature less than the melting point of the conductor 56. More specifically, the dielectric body 54 should preferably be made of single or complex oxide or complex nitride containing at least one material selected from a group consisting of, for example, barium oxide, bismuth oxide, titanium oxide, zinc oxide, neodymium oxide, titanium nitride, aluminum nitride, silicon nitride, alumina, silica, and mullite.

According to the present embodiment, the interior of the reactor 16 has been set to conditions for making it easy to generate an electric discharge therein. The conditions for making it easy to generate an electric discharge in the reactor 16 include a negative pressure established in the reactor 16, or a small discharge gap (gap length Dg) between the discharge electrodes 42 disposed in the reactor 16, or both of them. The negative pressure may fall within a range from −0.01 to −0.10 MPa, for example, and may be appropriately selected depending on the composition of the source gas 36, the number of the electrode pairs, etc. The discharge gap Dg should preferably be 10 mm or less, more preferably 1 mm or less, or much more preferably 0.5 mm or less.

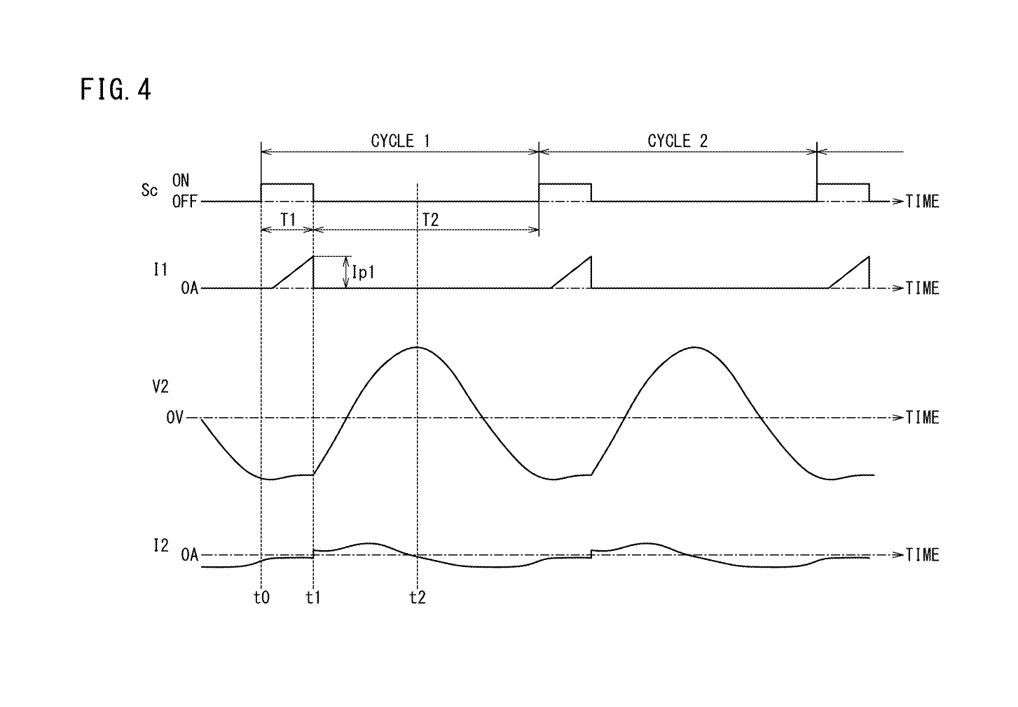

A processing sequence of operation of an ozone generator according to a reference example wherein the interior of the reactor 16 has been set to conditions for making it difficult to generate an electric discharge therein will be described below with reference to FIG. 4.

Firstly, at the start point t0 of the cycle 1, when the semiconductor switch 22 is switched ON, e.g., based on the input of the switching control signal Sc, voltage substantially equal to the power supply voltage E of the direct current power supply unit 14 is applied to the transformer 12 over the ON period T1 of the semiconductor switch 22. The primary current I1 flowing through the primary winding 18 of the transformer 12 increases linearly over time with a slope (E/L) where L denotes the primary inductance (excitation inductance) of the transformer 12. Induction energy is then accumulated in the transformer 12.

Thereafter, at the time point t1 where the primary current I1 reaches a predetermined peak value Ip1, when the semiconductor switch 22 is switched OFF, supply of high secondary voltage V2 to the reactor 16 is started and the secondary current I2 flows in the positive direction. Then, at the time point t2 where the secondary voltage V2 has a peak value, the secondary current I2 becomes zero. After the time point t2, the secondary current I2 flows in the negative direction.

The cycle 2 is started after the OFF period T2 of the semiconductor switch 22, and operation in the same manner as the above cycle 1 is repeated. Consequently, high secondary voltage V2 is applied to the reactor 16.

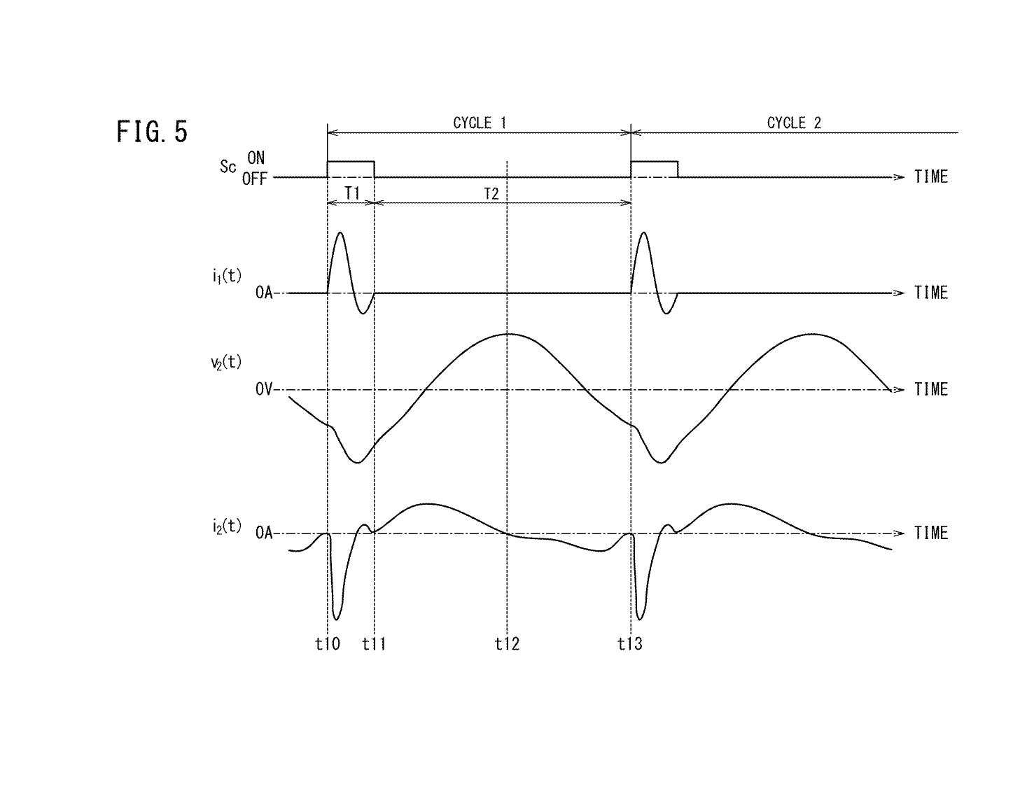

A processing sequence of operation of the ozone generator 10 according to the present embodiment will be described below with reference to FIG. 5.

According to the present embodiment, since the negative pressure is established in the reactor 16, it is easy to produce an electric discharge in the reactor 16.

As shown in FIG. 5, at start point t10 of cycle 1, the semiconductor switch 22 is switched ON in response to the switching control signal Sc applied thereto, for example. Then, during the ON period T1 of the semiconductor switch 22, a current (primary current i₁(t)) flows through the primary side of the transformer 12. The primary current i₁(t) has an oscillating waveform where it flows alternately in positive and negative directions. The primary current i₁(t) is based on the resonance of an LC circuit comprising at least a leakage inductance La of the transformer 12, a winding capacitance Ca of the transformer 12, and an electrode capacitance Cb between the discharge electrodes 42 of the reactor 16.

According to the reference example, since the primary current I1 ramps up during the ON period T1 of the semiconductor switch 22, it is difficult to carry out a turn-off operation on the semiconductor switch 22 at the time the primary current I1 becomes zero. According to the present embodiment, however, inasmuch as an alternating-current (AC) component due to resonance is added to a ramping-up component so that the primary current i₁(t) is oscillatory, it is possible to switch OFF the semiconductor switch 22 at the time the current becomes zero by turning off an ON signal for the semiconductor switch 22, i.e., carrying out a turn-off operation on the semiconductor switch 22, while the primary current i₁(t) is flowing in the negative direction.

According to the present embodiment, in particular, a leakage inductance La is established such that a turn-off operation on the semiconductor switch 22 is carried out during a period in which the primary current i₁(t) flows in the negative direction. As shown in FIG. 5, the primary current i₁(t) of the transformer 12 is zero at start point t10 (turn-on time) of the ON period T1 of the semiconductor switch 22. As a turn-off operation on the semiconductor switch 22 is carried out during the period in which the primary current i₁(t) flows in the negative direction, the semiconductor switch 22 can be switched OFF at the time the primary current i₁(t) becomes zero. Therefore, it is possible to switch ON and OFF the semiconductor switch 22 according to zero current switching (ZCS). The leakage inductance La can be established by adjusting the gap between the cores and the windings of the transformer 12 (e.g., the gaps between the windings and the cores) and the gap between the windings to appropriate settings, for example. Rather than establishing the leakage inductance La, the signal waveform of the switching control signal Sc output from the control circuit 24 may be changed to set an ON period T1 of the semiconductor switch 22 to a value which is longer than a ½ period of the primary current i₁(t), and equal to or shorter than one period of the primary current i₁(t).

According to the present embodiment, furthermore. an AC voltage (secondary voltage v₂(t)) is applied to the reactor 16 during the period (OFF period T2) from time point t11 when the semiconductor switch 22 is switched OFF till start point t13 of a next ON period T1. In FIG. 5, the secondary voltage v₂(t) gradually changes from a negative voltage to a positive voltage from time point t11, reaches a peak value at a substantially intermediate point t12 of the OFF period T2, and thereafter gradually changes toward a negative voltage. During the OFF period T2, therefore, a negative voltage and a positive voltage are successively applied to the reactor 16.

A current (secondary current i₂(t)) flowing through the secondary side of the transformer 12 has an oscillating waveform where it flows alternately in positive and negative directions. During the ON period T1 of the semiconductor switch 22, the secondary current i₂(t) has an oscillating waveform such that the secondary current i₂(t) is in opposite phase to the primary current i₁(t) and becomes zero at the time the primary current i₁(t) becomes zero. During the OFF period T2 of the semiconductor switch 22, the secondary current i₂(t) is of an oscillating waveform such that the secondary current i₂(t) becomes zero at time point t12 when the secondary voltage v₂(t) reaches a peak value.

Since the negative pressure is established in the reactor 16 of the ozone generator 10 according to the present embodiment, the primary current i₁(t) of the transformer 12 is an oscillating current based on the resonance of the LC circuit comprising at least the leakage inductance La of the transformer 12, the winding capacitance Ca of the transformer 12, and the electrode capacitance Cb between the discharge electrodes 42 of the reactor 16. Consequently, it is not necessary to switch OFF the semiconductor switch 22 at the peak value of the primary current I1 as is the case with the related art. Specifically, it is possible to carry out a turn-off operation on the semiconductor switch 22 at the time the primary current i₁(t) flows in the negative direction. Therefore, it is possible to switch ON and OFF the semiconductor switch 22 according to ZCS for thereby reducing a switching loss and noise and increasing the switching efficiency and the efficiency with which ozone is generated.

As a result, the ozone generator 10 according to the present embodiment is suitable as an ozone generator for use on vehicles, for example. In an application of the in-vehicle ozone generator, for example, ozone generated by the ozone generator is mixed into injection fuel in accordance with the timing of fuel injection into a combustion chamber to thereby promote ignition of the fuel.

According to the present embodiment, the leakage inductance La of the transformer 12 is determined such that a turn-off operation on the semiconductor switch 22 is carried out during the period in which the primary current i₁(t) flows in the negative direction, or the ON period T1 of the semiconductor switch 22 is set to a value which is longer than a ½ period of the primary current i₁(t), and equal to or shorter than one period of the primary current i₁(t). Therefore, it is possible to switch ON and OFF the semiconductor switch 22 according to ZCS.

Furthermore, during the OFF period T2, an AC voltage (secondary voltage v₂(t)), i.e., a negative voltage and a positive voltage, is successively applied to the reactor 16. The supply of energy into the reactor 16 is thus increased unlike the case where a pulse voltage is generated only during the ON period T1 of the semiconductor switch 22. The ozone generator 10 is thus capable of generating ozone more efficiently due to a synergetic effect of an electric discharge that is made easy to occur due to the negative pressure or the small discharge gap in the reactor 16 or both of them and the increased supply of energy into the reactor 16.

The ozone generator according to the present invention is not limited to the above embodiment, but may be changed or modified to incorporate various different arrangements without departing from the scope of the invention.

What is claimed is:

1. An ozone generator comprising:
a transformer;
a direct current power supply unit connected to a primary side of the transformer;
a reactor connected to a secondary side of the transformer;
a semiconductor switch connected between one end of a primary winding of the transformer and the direct current power supply unit; and
a control circuit configured to implement ON-OFF control of the semiconductor switch using a set switching frequency to thereby apply a voltage to the reactor;
wherein an interior of the reactor is set to conditions for making it easy to generate an electric discharge in the reactor.

2. The ozone generator according to claim 1, wherein the control circuit carries out a turn-on operation on the semiconductor switch at a time a primary current of the transformer is zero, and carries out a turn-off operation on the semiconductor switch at a time the primary current flows in a negative direction.

3. The ozone generator according to claim 1, wherein the primary current that flows during an ON period of the semiconductor switch is an oscillating current based on resonance of an LC circuit comprising at least a leakage inductance of the transformer, a winding capacitance of the transformer, and a capacitance between discharge electrodes of the reactor; and
the leakage inductance is established such that a turn-off operation on the semiconductor switch is carried out during a period in which the primary current is flowing in a negative direction.

4. The ozone generator according to claim 1, wherein the primary current that flows during an ON period of the semiconductor switch is an oscillating current based on resonance of an LC circuit comprising at least a leakage inductance of the transformer, a winding capacitance of the transformer, and a capacitance between discharge electrodes of the reactor; and
the ON period of the semiconductor switch is set to a value which is longer than a ½ period of the primary current, and equal to or shorter than one period of the primary current.

5. The ozone generator according to claim 1, wherein an alternating current voltage is applied to the reactor during an OFF period of the semiconductor switch.

6. The ozone generator according to claim 1, wherein the reactor includes one or more electrode pairs each comprising two discharge electrodes spaced from each other by a predetermined gap length; and
the reactor generates ozone by allowing a source gas to pass through a space between at least the two discharge electrodes of the electrode pair and then producing electric discharge between the two discharge electrodes by the voltage applied between the two discharge electrodes.
